(19) United States
(12) Patent Application Publication
(10) Pub. No.: US 2025/0286340 A1
(43) Pub. Date: Sep. 11, 2025

(54) OPTICAL AMPLIFIER FOR AMPLIFYING POLARISED SIGNAL LIGHT

(71) Applicant: PHYSIKALISCH-TECHNISCHE BUNDESANSTALT BRAUNSCHWEIG UND BERLIN, Braunschweig (DE)

(72) Inventors: Jaffar Emad KADUM, Braunschweig (DE); Sebastian KOKE, Wolfenbüttel (DE); Mattias MISERA, Edemissen (DE)

(21) Appl. No.: 18/857,369

(22) PCT Filed: Apr. 19, 2023
(86) PCT No.: PCT/EP2023/060097

§ 371 Date: Oct. 16, 2024

(30) Foreign Application Priority Data
Apr. 21, 2022 (DE) 10 2022 109 685.8

(51) Int. Cl. H01S 3/30; H01S 3/10

(52) U.S. Cl. CPC H01S 3/30; H01S 3/10061

(57) ABSTRACT

The invention relates to an optical amplifier for amplifying polarized signal light (12) with an optical fiber (14) for guiding the signal light (12) comprising a signal light input (16) for coupling in the signal light (12) and a signal light output (18) that is spaced apart from the signal light input; a signal light Brillouin amplifier (20) comprising a signal light amplification pump laser (22) designed to generate signal light amplification pump light (24), which is arranged to amplify the signal light (12) by means of stimulated Brillouin scattering, and a signal light amplification pump light coupler for coupling the signal light amplification pump light (24) into the optical fiber (14), wherein a signal polarization adjuster (38) designed to adjust a signal light polarization (P₁₂) of the signal light (12) entering through the signal light input (16) to a predetermined signal light target polarization (P_{12,soll}) and/or a back light polarization adjuster (28) designed to adjust a back light polarization (P_{R}) of back light (30) entering through the signal light output, so that the back light polarization (P_{R}) corresponds to a signal light polarization (P_{S}) of the signal light (12).

The invention relates to an optical amplifier for amplifying polarized signal light, with (a) an optical fiber for guiding the signal light that comprises (i) a signal light input for coupling in the signal light and (ii) a signal light output spaced apart from the signal light input, (b) a signal light Brillouin amplifier that (i) comprises a signal light amplification pump laser that is designed to generate signal light amplification pump light, which (ii) is arranged to amplify the signal light by means of stimulated Brillouin scattering, and (iii) comprises a signal light amplification pump light coupler for coupling the signal light amplification pump light into the optical fiber.

Such optical amplifiers are used to provide a frequency from a frequency source to a frequency receiver at a location remote from the frequency source. An optical fiber is arranged between the frequency source and the frequency receiver for the purpose of guiding the signal light. Changes in the environment surrounding the optical fiber cause fluctuation in the optical path length of the optical fiber. These fluctuations lead to a fluctuation in the frequency of the signal light at the frequency receiver. To reduce the uncertainty with which the frequency is received at the frequency receiver, these fluctuations in frequency have to be compensated.

This is often achieved by reflecting the signal light at the frequency receiver. The resulting back light passes through the same optical fiber, so that the effect of the changing optical path length is duplicated in the return light. This allows the interference caused by the changing optical path length to be determined and compensated for.

In addition, there is a loss of intensity of the signal light in the optical fiber. If the frequency is to be transmitted across longer distances, the signal light and the back light have to be amplified. It is desirable to minimize uncertainty in the transmission of the frequency.

The invention aims to improve the amplification of signal light, particularly for the purpose of transmitting a frequency from a frequency source to a frequency receiver.

The invention solves the problem by way of an optical amplifier according to the preamble with a back light polarization adjuster designed to adjust a back light polarization of back light entering through the signal light output so that the back light polarization corresponds to a signal light polarization of the signal light.

Alternatively or additionally, the optical amplifier has a signal light polarization adjuster designed to adjust a signal light polarization of signal light entering through the signal light output to a predetermined target polarization, in particular so the signal light polarization corresponds to the back light polarization of the back light.

The advantage of the invention is that the frequency of the signal light can be transmitted with an especially low degree of uncertainty. Amplifiers according to the prior art are constructed in such a way that the back light polarization is different from the signal light polarization. For example, the two polarizations are perpendicular to each other. However, this means that the correction of the frequency is based on frequency fluctuations experienced by light from different polarization directions. However, it has been proven that the environmental influences acting on the optical fibers cause fluctuations in the optical path length that are dependent on polarization. This can mean that an error may occur when compensating the fluctuations of the optical path length of the optical fiber. Since the signal light and the back light have the same polarization in the optical amplifier according to the invention, this error cannot occur. The frequency can thus be transmitted with less uncertainty.

Within the scope of the present description, the signal light input refers to a component or a point of the optical amplifier at which signal light can be coupled in.

The signal light output refers to a component or a point of the optical amplifier at which the signal light is decoupled or leaves the optical amplifier. In principle, the optical amplifier is a closed device. However, it is also possible that the optical fiber used to transmit the signal light and the back light extends to the frequency source and/or to the frequency receiver.

The signal light Brillouin amplifier refers to an amplifier that amplifies light on the basis of the stimulated Brillouin scattering.

The optical fiber refers to a fiber that is designed to direct the signal light. The optical fiber is preferably a glass fiber.

The feature that the back light polarization corresponds to the signal light polarization is understood particularly to mean that the polarization plane of the back light on the signal light polarization adjuster corresponds to the polarization plane of the signal light on the signal light polarization adjuster and/or that the polarization place of the back light on the back light polarization adjuster corresponds to the polarization plane of the signal light on the back light polarization adjuster. It is possible, but not essential, that the polarization planes are the same, i.e. the angle between the two polarization places is zero. However, it is also possible that the angle is at most 10°, in particular at most 5°.

According to one preferred embodiment, the optical amplifier has a signal light polarization gauge for determining the signal light polarization P_{S}. The signal light polarization can be determined by means of the signal light polarization gauge. The back light polarization adjuster is matched to the signal light polarization gauge, so that the back light polarization adjuster can adjust the polarization of the back light to that of the signal light. It should be noted that it is irrelevant for the optical amplifier which light is considered signal light and which light is considered back light. Light from a frequency source can also be considered back light and the light emitted by the frequency receiver can also be considered signal light. The terms ‘signal light’ and ‘back light’ serves merely to simplify the description.

It is especially favorable if the optical amplifier has a signal light polarization adjuster that is designed to adjust a signal light polarization of the signal light to a predetermined signal light target polarization P_{S,soll}. In this case, the signal light polarization gauge is a component of the signal light polarization adjuster. In particular, the signal light target polarization corresponds to the polarization that results in the maximum amplification in the optical amplifier. In particular, the signal light target polarization is selected in such a way that the signal light amplification pump light has the same polarization at a beam splitter for coupling in the signal light amplification pump light as the signal light. It is especially favorable if the signal light polarization gauge is designed in such a way that the polarization of the signal light amplification pump light can also be determined as well as for the polarization adjustment of signal light and signal light amplification pump light.

According to one preferred embodiment, the optical amplifier has a back light Brillouin amplifier which comprises (a) a back light amplification pump laser designed to generate back light amplification pump light and (b) is arranged to amplify the back light by means of stimulated Brillouin scattering and (c) comprises a signal light amplification pump light coupler for coupling in the signal light amplification pump light into the optical fiber.

As such, the optical amplifier is a bi-directional amplifier that amplifies both the signal light and the back light. It is favorable if the back light amplification pump laser and the signal light amplification pump laser are arranged in a common housing or two connected housings.

The advantage of this is that this optical amplifier can be used in multiple ways. It can be advantageous to distribute the optical frequency from the frequency source to not only one frequency receiver, but to two, three or more frequency receivers. In this case, in order to determine the change, the optical path from which the frequency receiver reflected the back light must be known. This can be achieved, for example, by each frequency receiver modulating an additional constant offset frequency onto the back light. However, in order to achieve the best possible amplification, the Brillouin frequency has to be hit precisely. Therefore, an offset frequency has to be compensated in the amplifier. By using two pump lasers, the amplifier can be easily adapted to different offset frequencies.

According to one preferred embodiment, the optical amplifier has (a) a back light pump light frequency modulator for amending a back light pump light frequency (ν_{B}) of the back light amplification pump light, (b) a back light intensity gauge for measuring a back light intensity of the back light which is arranged upstream of the back light amplification pump light coupler in the back light propagation direction, and (c) a back light frequency regulator that is connected to the back light amplification pump light frequency modulator and the back light intensity gauge for the purpose of regulating the back light pump light frequency (ν_{B}) to a maximum back light intensity.

The advantage of this is that it enables especially high amplification. Maximum amplification occurs at the Brillouin frequency. However, this can fluctuate. The back light frequency regulator means that the back light amplification pump light always corresponds to the Brillouin frequency as precisely as possible.

It is beneficial if the signal light Brillouin amplifier has a Brillouin frequency detection device for time-dependent detection of a Brillouin frequency ν_{BFS} at which the signal light is amplified to the maximum degree, wherein the Brillouin frequency detection device is connected to the signal light amplification pump laser for the purpose of adjusting the signal light pump light frequency ν_{F}. This enables optimum amplification of the signal light, as described above for the amplification of the back light.

Preferably, the Brillouin frequency detection device comprises (a) a signal light amplification pump light frequency modulator for modifying a signal light pump light frequency ν_{F} of the signal light pump light, (b) a signal light intensity gauge for measuring a signal light intensity of the signal light in the signal light propagation direction, said gauge being arranged upstream of the signal light amplification pump light coupler, and (c) a signal light frequency regulator connected to the signal light amplification pump light frequency modulator and the signal light intensity gauge for regulating the signal pump light frequency to the maximum signal light intensity.

The Brillouin amplification is optimal when the pump light has the same polarization as the light to be amplified. The optical amplifier therefore preferably has a pump laser polarization adjustment device designed to control or regulate a back light amplification pump light polarization of the back light amplification pump light and/or a signal light amplification pump light polarization of the signal light amplification pump light, so that these polarizations correspond to one another in the optical fiber.

It is possible that the pump laser polarization adjustment device is only connected to the signal light pump laser, only to the back light pump laser or to both pump lasers, and regulates the respective polarization.

The pump laser polarization adjustment device preferably has (a) a low-frequency photodiode that determines a beat frequency (f_{b2}) between the back light pump light frequency (ν_{B}) and the signal light pump light frequency (ν_{F}) and (b) a phase lock loop, which is connected to the low-frequency photodiode and the signal light amplification pump laser and/or the back light amplification pump laser. A low-frequency photodiode is understood to mean a photodiode that can detect frequencies between 0 MHz and 500 MHz. Preferably, the low-frequency photodiode is designed to detect a frequency between 50 and 250 MHz.

In order to adjust the signal light pump light frequency ν_{F}, the signal light Brillouin amplifier preferably has a signal light phase stabilization device with a high-frequency photodiode. The high-frequency photodiode is preferably arranged to detect a beat frequency f_{b1} between a signal light frequency vs of the signal light and the signal light pump light frequency ν_{F}.

Preferably, the optical amplifier has (a) a beam splitter with a signal light input connected to the signal light input port, particularly to the signal light polarization gauge, a back light input connected to the signal light output, particularly to the back light polarization adjuster, a signal light amplification pump light input connected to the signal light amplification pump laser, and a back light amplification pump light input connected to the back light amplification pump laser. It is favorable if the optical amplifier comprises (b) a circulator that is connected to the beam splitter at a first port, to the back light amplification pump laser at a second port, and to the low-frequency photodiode at a third port.

Alternatively or additionally, the optical amplifier may have (a) a signal light amplification pump laser cavity which comprises (i) a highly reflective signal light amplification pump light coupling-in element and (ii) an optical insulator, (iii) wherein the signal light strikes the signal light amplification pump light coupling-in element at an incident angle to a normal, and (b) a back light amplification pump laser cavity which comprises (i) a highly reflective back light amplification pump light coupling-in element and (ii) an optical insulator, (iii) wherein the back light strikes the back light amplification coupling-in element at an incident angle to a normal. The advantage of this arrangement is that it is both highly effective for the signal light and couples the signal light amplification pump light into the optical fiber with high efficiency. Preferably, the length of the signal light amplification pump laser cavity is designed in such a way that the coupling-in back light, which is frequency-shifted in relation to the signal light amplification pump light, lies at the transmission minimum of the signal light amplification pump laser cavity. The length of the back light amplification pump laser cavity is preferably designed in such a way that coupled-in signal light lies at the transmission minimum of the back light amplification pump laser cavity.

The invention also includes an optical network with (a) a frequency source for emitting signal light, (b) a frequency receiver, (c) an optical fiber line from the frequency source to the frequency receiver, (d) at least one optical amplifier according to one of the preceding claims which (i) is arranged between the frequency source and the frequency receiver, (ii) comprises a signal light input for coupling-in the signal light and (iii) a signal light output that is spaced apart from the signal light input, (iv) has a signal light amplification pump laser designed to generate signal light amplification pump light, (v) which is arranged to amplify the signal light by means of stimulated Brillouin scattering and (vi) has a signal light amplification pump light coupler for coupling in the signal light amplification pump light into the optical fiber, (e) back light polarization adjuster designed to adjust a back light polarization of back light that corresponds to a signal light polarization of the signal light and/or a signal light polarization adjuster designed to adjust a signal light polarization of the signal light to a predetermined signal light target polarization.

A distance between the frequency source and the frequency receiver is preferably at least 100 km. The frequency source is preferably an atomic clock. According to one preferred embodiment, this atomic clock has an Allan variance of at most 10⁻¹⁶, in particular at most 10⁻¹⁷, at an averaging time τ of 100 seconds.

The invention also includes a cascade consisting of at least two optical amplifiers according to the preamble of claim 1 that have a signal light polarization adjuster. The signal light polarization adjuster of the next optical amplifier in the signal light propagation direction then compensates the polarization fluctuations in the optical fiber line.

In the following, the invention will be explained in more detail with the aid of the accompanying drawings. They show:

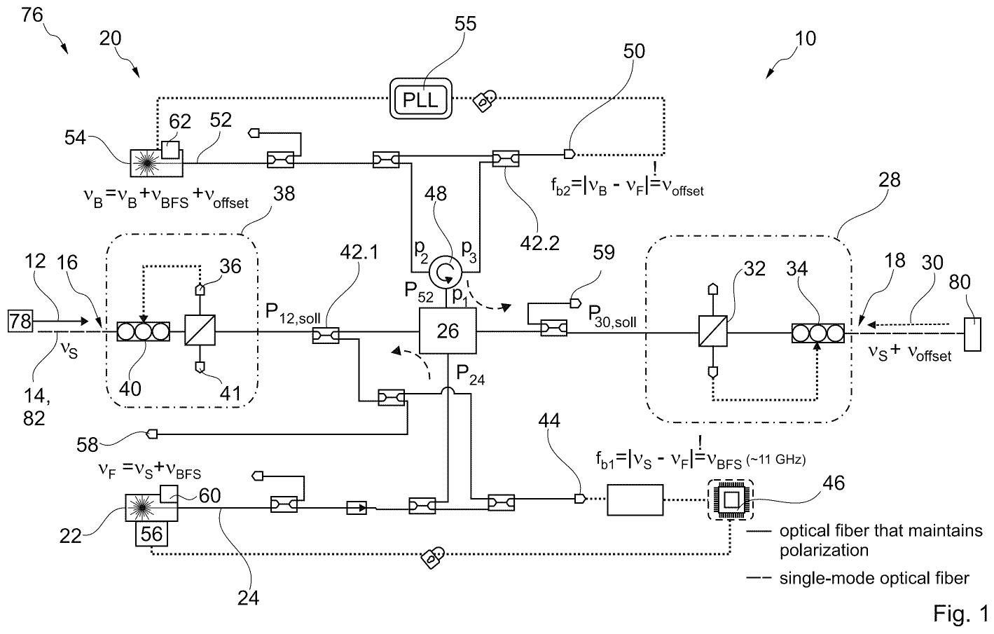

FIG. 1 the structure of an optical amplifier according to the invention,

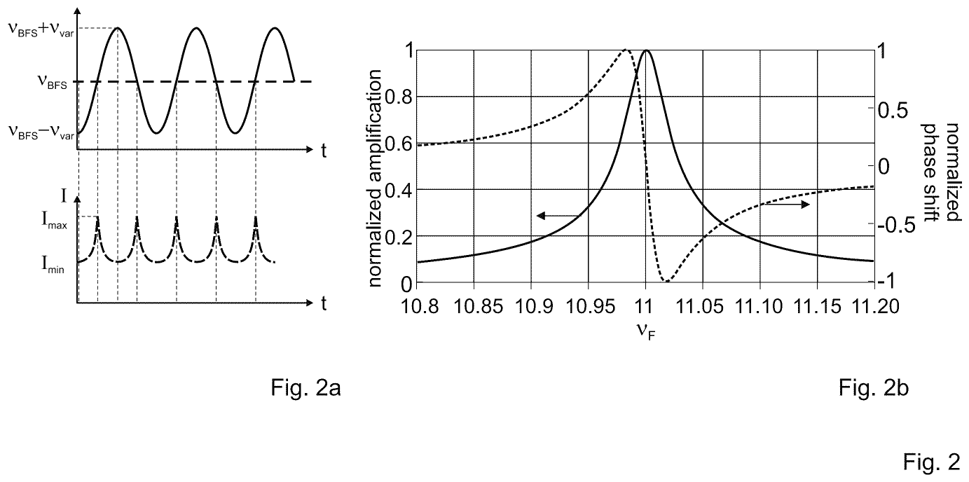

FIG. 2 in partial FIG. 2a, the dependence of the amplification on the signal light pump light frequency ν_{F} and
In addition in partial FIG. 2b, the dependence of the normalized phase shift on the signal light pump light frequency ν_{F} and

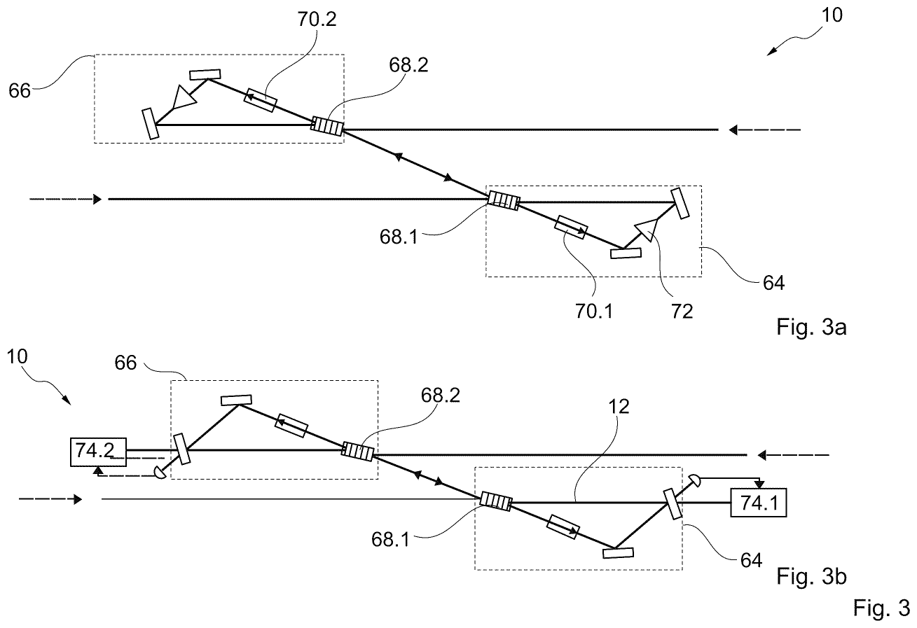

FIG. 3 in FIGS. 3a and 3b, schematic arrangements of optical amplifiers according to further embodiments.

FIG. 1 depicts a circuit diagram of an optical amplifier 10 according to the invention for amplifying polarized signal light 12, which is schematically depicted as an arrow. The optical amplifier 10 has an optical fiber 14 that maintains polarization for guiding the signal light from a signal light input 16 to a signal light output 18. Signal light 12 entering the signal light input 16 is amplified by a signal light Brillouin amplifier 20. The amplification is preferably at least 30 dB.

The signal light Brillouin amplifier 20 has a signal light amplification pump laser 22 for generating signal light amplification pump light 24 with a signal light pump light frequency ν_{F} and a signal light amplification pump laser polarization P₂₄. The signal light amplification pump light 24 is fed into the optical fiber 14 by means of a beam splitter 26 against the propagation direction of the signal light 12. The beam splitter 26 may be a 35/65 beam splitter, for example.

A back light polarization adjuster 28 changes a back light amplification pump laser polarization P₂₈ of back light 28 entering the signal light output 18, so that said polarization corresponds to the signal light amplification pump laser polarization P₂₄. To this end, the back light polarization adjuster 28 has a back light polarization gauge 32 for measuring the back light polarization P₂₈ and a polarization rotator 34. Downstream of the back light polarization adjuster 28 in the back light propagation direction, the back light 30 has a back light target polarization P_{30,soll}. The back light polarization gauge 32 simultaneously measures the back light amplification pump laser polarization for the purposes of controlling or regulating the back light amplification pump light polarization.

A signal light polarization gauge 26 is arranged downstream of the signal light input 16 in the direction of light propagation and detects a signal light polarization P₁₂. The signal light polarization gauge 26 is preferably part of a signal light polarization adjuster 38 which comprises a second polarization rotator 40 and rotates the signal light polarization P₁₂ in such a way that it corresponds to a signal light target polarization P_{12,soll} upon entering the beam splitter 26. In particular, the signal light polarization P₁₂ is adjusted to the signal light amplification pump laser polarization. The following therefore preferably applies: P_{12,soll}=P₂₄.

A part of the signal light 12 is decoupled by means of a first coupler 42.1 and fed to a high-frequency photodiode 44, where it is superimposed with signal light amplification pump light 24. This results in a beat frequency f_{b1}. Using a first optical phase lock loop 46, the signal light amplification pump laser 22 is regulated in such a way that the signal light amplification pump light 24 has a frequency that lies above the signal light frequency vs by the Brillouin frequency ν_{BFS}. The Brillouin frequency is approximately ν_{BFS}=11 GHz.

In the present case, after passing through the beam splitter 26, signal light amplification pump light 24 is guided by means of a second coupler 42.2 to a low-frequency photodiode, where it is superimposed with back light amplification pump light 52 of a back light amplification pump laser 54. This results in a second oscillation frequency f_{b2}, which corresponds to an offset frequency ν_{offset} between the signal light frequency vs and the frequency of the back light. For example, the offset frequency lies in the interval ν_{offset} ∈[50 MHz; 150 MHz]

Using a second optical phase lock loop 55, the back light pump light frequency ν_{B} of the back light amplification pump light 52 is regulated to ν_{B}=ν_{S}+ν_{BFS}+ν_{offset}.

The back light amplification pump light 52 is guided to the beam splitter 26 by means of the circulator 48. To this end, a first port p1 of the circulator 48 is connected to the beam splitter 26. A second port p2 is connected to the back light amplification pump laser 52; a third port p3 leads to the second coupler 42.2.

The two pump lasers 22, 54 are distributed feedback lasers, for example. They can have a bandwidth of 2 Mhz±10% and an optical output of, for example, 100 milliwatt.

The second optical phase lock loop 55 can be an FPGA (field programmable gated array). The bandwidth of the phase lock loop 54 is, for example, 300 KHz.

The first phase lock loop 46 is designed as a Brillouin frequency detection device and signal light frequency regulator which interacts with a signal light amplification pump light frequency modulator 56 of the signal light amplification pump laser 22 and can alter the signal light pump light frequency ν_{F}.

FIG. 2a illustrates the change in the signal light pump light frequency ν_{F} as a function of the time t. For example, the signal light pump light frequency ν_{F} fluctuates in the interval [ν_{F}−νᵥₐᵣ; ν_{F}+νᵥₐᵣ] with a variation frequency νᵥₐᵣ. For the variation frequency, for example νᵥₐᵣ=7.5 MHz.

The signal light intensity 112 of the amplified signal light is depicted below the time-dependent fluctuating signal light pump light frequency ν_{F}, the former being measured by a signal light intensity gauge 58. The intensity of the back light is measured by means of a back light intensity gauge 59.

FIG. 2b shows the dependence of the signal light amplification normalized to 1 on the difference between the back light pump light frequency ν_{F} and the signal light frequency ν_{S}.

FIG. 1 shows that the optical amplifier 10 can comprise a pump laser polarization adjustment device in the form of a signal light amplification polarization adjustment device 60 designed to control or regulate the signal light amplification pump laser polarization P₂₄, so that it corresponds to a back light amplification pump light polarization P₅₂ of the back light amplification pump light 52 in the optical fiber 14.

This signal light amplification polarization adjustment device 60 comprises a device for measuring and a device for altering the signal light amplification pump laser polarization P₂₄.

Alternatively or additionally, the back light amplification pump laser 54 can comprise a back light amplification polarization adjustment device 62 for adjusting the back light amplification pump light polarization P₅₂ to the signal light amplification pump laser polarization P₂₄.

FIG. 3a depicts a second embodiment of an optical amplifier 10 according to the invention comprising a signal light amplification pump laser cavity 64 as well as a back light amplification pump laser cavity 66.

The signal light amplification pump laser cavity 64 has a first highly reflective signal light amplification pump light coupling-in element 68.1 which can be designed, for example, as a volume Bragg grating, as well as an optical insulator 70.1. For example, the degree of reflection of the signal light amplification pump light 68.1 is at least 90%. Preferably, the length of the signal light amplification pump laser cavity is designed in such a way that coupled-in back light lies on a transmission minimum of the signal light amplification pump laser cavity or is filtered out via other properties.

The back light laser cavity 66 has a highly reflective back light amplification pump light coupling-in element 68.2 as well as a second optical insulator 70.2. Preferably, the length of the back light amplification pump laser cavity is designed in such a way that coupled-in signal light lies at a transmission minimum of the signal light amplification pump laser cavity or is filtered out via other properties.

FIG. 3b depicts a third embodiment of an optical amplifier 10 according to the invention which comprises an additional signal light amplification pump laser 74.1, which is coupled to the signal light amplification pump light boost cavity 64 by phase coupling. A further laser 74.2 is coupled to the back light amplification pump light boost cavity 66 by phase coupling.

An optical network 76 (see FIG. 1) according to the invention has a frequency source 78, in particular an atomic clock, and a frequency receiver 80. The optical fiber 82 leads from the frequency source 78 to the signal light input 16.

Reference list

| | |
|---|---|
| 10 | optical amplifier |
| 12 | signal light |
| 14 | optical fiber |
| 16 | signal light input |
| 18 | signal light output |
| 20 | signal light Brillouin amplifier |
| 22 | signal light amplification pump |
| | laser |
| 24 | signal light amplification pump |
| | light |
| 26 | beam splitter |
| 28 | back light polarization adjuster |
| 30 | back light |
| 32 | back light polarization gauge |
| 34 | back light polarization rotator |
| 36 | signal light polarization gauge |
| 38 | signal light polarization adjuster |
| 40 | signal light polarization rotator |
| 42 | coupler |
| 44 | high-frequency photodiode |
| 46 | phase lock loop |
| 48 | circulator |
| 50 | low-frequency photodiode |
| 52 | back light amplification pump light |
| 54 | back light amplification pump |
| | laser |
| 55 | second phase lock loop, signal |
| | light frequency regulator |
| 56 | signal light amplification pump |
| | light frequency modulator |
| 58 | signal light intensity gauge |
| 59 | back light intensity gauge |
| 60 | signal light amplification |
| | polarization adjustment device |
| 62 | back light amplification |
| | polarization adjustment device |
| 64 | signal light laser cavity |
| 66 | back light laser cavity |
| 68.1 | signal light coupling-in element |
| 68.2 | back light coupling-in element |
| 70 | optical insulator |
| 72 | Brillouin amplifier |
| 74 | laser |
| 76 | network |
| 78 | frequency source |
| 80 | frequency receiver |
| ν_{B} | back light pump light frequency |
| ν_{BFS} | Brillouin frequency |
| ν_{F} | signal light pump light frequency |
| ν_{offset} | offset frequency |
| ν_{S} | signal light frequency |
| f_{b1} | first beat frequency |
| f_{b2} | second beat frequency |
| I₁₂ | signal light intensity |
| p | port |
| P₁₂ | signal light polarization |
| P_{12, soll} | signal light target polarization |
| P₂₄ | signal light amplification pump |
| | laser polarization |
| P₃₀ | back light polarization |
| P_{30, soll} | back light polarization |
| P₅₂ | back light amplification pump |
| | laser polarization |
| t | time |

1. An optical amplifier for amplifying polarized signal light, comprising:
(a) an optical fiber for guiding a signal light comprising
(i) a signal light input for coupling in the signal light, and
(ii) a signal light output spaced apart from the signal light input;
(b) a signal light Brillouin amplifier comprising
(i) a signal light amplification pump laser designed to generate signal light amplification pump light,
(ii) wherein the signal light amplification laser is arranged to amplify the signal light by stimulated Brillouin scattering, and
(iii) a signal light amplification pump light coupler for coupling the signal light amplification pump light into the optical fiber; and
one or more of
(c) a signal polarization adjuster designed to adjust a signal light polarization of the signal light entering through the signal light input to a predetermined signal light target polarization; and
(d) a back light polarization adjuster designed to adjust a back light polarization of back light entering through the signal light output so that the back light polarization corresponds to a signal light polarization of the signal light.

2. The optical amplifier according to claim Error! Reference source not found., wherein the signal light polarization corresponds to the back light polarization.

3. The optical amplifier according to claim 1 further comprising a signal light polarization gauge for determining the signal light polarization.

4. The optical amplifier according to claim 1 further comprising a back light Brillouin amplifier comprising
(a) a back light amplification pump laser designed to generate back light amplification pump light,
(b) wherein the back light amplification pump laser is arranged to amplify back light by stimulated Brillouin scattering, and
(c) a back light amplification pump light coupler for coupling the back light amplification pump light into the optical fiber.

5. The optical amplifier according to claim 1 further comprising:
(a) a back light pump light frequency modulator for modifying a back light pump light frequency of back light amplification pump light;
(b) a back light intensity gauge for measuring a back light intensity of back light, wherein the back light intensity gauge is arranged upstream of a back light amplification pump light coupler in a back light propagation direction; and
(c) a back light frequency regulator connected to the back light amplification pump light frequency modulator and the back light intensity gauge for regulating the back light pump light frequency to a maximum back light intensity.

6. An optical amplifier according to claim 1 wherein
(a) the signal light Brillouin amplifier comprises a Brillouin frequency detection device for time-dependent detection of a Brillouin frequency at which the signal light is amplified to a maximum degree, wherein the Brillouin frequency detection device is connected to the signal light amplification pump laser for adjusting the signal light pump light frequency, wherein
(b) the Brillouin frequency detection device comprises
(i) a signal light amplification pump light frequency modulator for modifying a signal light pump light frequency of the signal light pump light,
(ii) a signal light intensity gauge for measuring a signal light intensity of the signal light arranged upstream of the signal light amplification pump light coupler in the signal light propagation direction, and
(iii) a signal light frequency regulator which is connected to the signal light amplification pump light frequency modulator and the signal light intensity gauge for regulating the signal light pump light frequency to a maximum signal light intensity.

7. The optical amplifier according to claim 1 further comprising a pump laser polarization adjustment device designed to control or regulate a back light amplification pump light polarization of back light amplification pump light and/or a signal light amplification pump light polarization of the signal light amplification pump light, so that the back light amplification pump light polarization and the signal light amplification pump light polarization correspond to one another in the optical fiber.

8. The optical amplifier according to claim 1 further comprising a back light pump laser polarization adjustment device designed to control or regulate a back light amplification pump light polarization of the back light amplification pump light.

9. The optical amplifier according to claim 1 further comprising a signal light pump laser polarization adjustment device designed to control or regulate a signal light amplification pump light polarization of signal light amplification pump light so that the signal light amplification pump light polarization and a back light amplification pump light polarization correspond to one another in the optical fiber on the coupler.

10. The optical amplifier according to claim 1 wherein
(a) the signal light Brillouin amplifier comprises a signal light phase stabilization device that has a high-frequency photodiode, and
(b) the high-frequency photodiode is arranged to detect a beat frequency between a signal light frequency of the signal light and the signal light pump light frequency.

11. The optical amplifier according to claim 1 further comprising:
(a) a beam splitter with
(i) a signal light input port connected to the signal light input,
(ii) a back light input port connected to the signal light output,
(iii) a signal light amplification pump light input connected to a signal light amplification pump laser, and
(iv) a back light amplification pump light input connected to a back light amplification pump laser, and
(b) a circulator which
(i) is connected to the beam splitter at a first port,
(ii) is connected to the back light amplification pump laser at a second port, and
(iii) is connected to the low-frequency photodiode at a third port.

12. The optical amplifier according to claim 1 further comprising:
(a) a signal light amplification pump laser cavity or a signal light amplification pump light boost cavity, which comprises
(i) a highly reflective signal light amplification pump light coupling-in element, and
(ii) a first optical insulator,
(iii) wherein the signal light strikes the signal light amplification pump light coupling-in element at an incident angle to a normal, and
(b) a back light amplification pump laser cavity or a back light amplification pump light boost cavity, which comprises
(i) a highly reflective back light amplification pump light coupling-in element, and
(ii) a second optical insulator,
(iii) wherein the back light strikes the back light coupling-in element at an incident angle to a normal.

13. An optical network, comprising:
(a) a frequency source for emitting signal light,
(b) a frequency receiver,
(c) an optical fiber line from the frequency source to the frequency receiver,
(d) at least one optical amplifier according to claim 1 which
(i) is arranged between the frequency source and the frequency receiver, and
(ii) comprises a signal light input for coupling in the signal light,
(iii) a signal light output spaced apart from the signal light input,
(iv) a signal light amplification pump laser designed to generate signal light amplification pump light,
(v) wherein the signal light amplification pump laser is arranged to amplify the signal light by stimulated Brillouin scattering, and
(vi) a signal light amplification pump light coupler for coupling the signal light amplification pump light into the optical fiber, and one or more of
(e) a back light polarization adjuster designed to adjust a back light polarization of back light that corresponds to a signal light polarization of the signal light, and
(f) a signal light polarization adjuster designed to adjust a signal light polarization of the signal light (12) to a predetermined signal light target polarization.

14. The optical amplifier of claim 11 further comprising one or more of
a signal light polarization gauge connected to the signal light input port,
a back light polarization gauge connected to the back light input port
